(19) United States
(12) Patent Application Publication
(10) Pub. No.: US 2019/0047800 A1
(43) Pub. Date: Feb. 14, 2019

(54) UNIVERSAL PALLET STACKER

(71) Applicant: NILCO, LLC, Hartville, OH (US)

(72) Inventor: Michael HOAG, Sanibel Island, FL (US)

(73) Assignee: NILCO, LLC, Hartville, OH (US)

(21) Appl. No.: 15/676,784

(22) Filed: Aug. 14, 2017

(51) Int. Cl. B65G 57/03

(52) U.S. Cl. CPC B65G 57/03; B65G 2201/0267

(57) ABSTRACT

Disclosed universal pallet stackers may include a frame, a pallet transport assembly, a pallet delivery assembly, and at least one stop plate that extends above the transport assembly. The transport assembly may include moveable transport tracks that receive an assembled pallet and move it downstream until it contacts the upstream side of the stop plate. The pallet delivery assembly may include extendable arms that: lift the pallet above the stop plate, move the pallet downstream of the plate, bring the pallet into contact with the downstream side of the stop plate, and slide the pallet off of the arm assemblies to thereby stack the pallet in a stacking location. Associated methods of using universal pallet stackers are also disclosed.

### BACKGROUND OF THE INVENTION

### 1. Field of the Invention

The present invention is directed to the field of shipping pallet manufacture. More particularly, the invention relates to universal pallet stackers that are capable of receiving and stacking assembled pallets of different sizes to thereby enable a seamless transition between manufacturing runs of different pallet sizes. Accordingly, the general objects of the invention are to provide novel methods and apparatus of such character.

### 2. Description of the Related Art

The worldwide popularity of wooden shipping pallets for use in transporting products has led to a wide variety of pallet shapes and sizes. For this reason, pallet manufacturers are commonly called upon to assemble many different sized wooden pallets in the fastest and least expensive way possible. Not surprisingly, various machines have arisen to more easily and quickly respond to different customer demands. For example, U.S. Pat. No. 5,355,575 (application Ser. No. 08/013,751) entitled “PALLET MOVING DEVICE” and issued on Oct. 18, 1994 describes methods and apparatus for assembling pallets, transporting the assembled pallets, and then stacking those pallets. U.S. Pat. No. 5,355,575 is hereby incorporated by reference in its entirety herein.

Other prior art innovations in the pallet making field include the reconfigurable pallet workspace and transport apparatus 20 shown in FIGS. 1 and 2 herein. As shown therein, conventional apparatus 20 includes a reconfigurable assembly table 22 with a bottom lip 23 and a work surface 27 having an array of apertures therethrough. To assemble a pallet of any given size, a user inserts a plurality of assembly pins/guides (not shown) that dictate the size and style of a pallet to be assembled for a particular manufacturing run. To reconfigure table 22 for a different assembly run the pins/guides are simply removed and replaced in different locations before the next run begins. Table 22 is pivotably mounted on a frame 21 by a support leg 24 and a drive assembly 25 (such as a linkage physically connected between the table and some kind of actuator—e.g., a hydraulic piston or an electric motor—as is known in the art).

In use, the table 22 is tilted from a horizontal position to an angled position (in response to drive assembly 25) in which a pallet P′ is assembled. Once pallet P′ has been assembled, table 22 is tilted back to the prior horizontal position. Plural transport tracks 34a, 34b, 34c, and 34d may then linearly move pallet P′ in a downstream direction to an intermediate position of the workspace/transport 20 (see FIGS. 3 and 4) in response to movement of conventional transport drive assemblies 35. Assemblies 35 may include conveying chains, conveyor belts, rollers, wheels, etc., or other equivalents known in the art such as the apparatus and methods of the aforementioned U.S. Pat. No. 5,355,575.

As an option, the assembled pallet P′ may be inverted as shown in FIGS. 5 and 6. In particular, pallet P′ may be tilted upward by plural conventional upstream flipper arm assemblies 26a, 26b, 26c, and 26d by upward rotation of same. At the same time plural conventional downstream flipper arm assemblies 30a, 30b, 30c, and 30d rotate upward. Once pallet P′ is flipped past vertical, it falls (partially inverted) onto arm assemblies, 30a, 30b, 30c, and 30d. As all of arm assemblies 26a, 26b, 26c, 26d, 30a, 30b, 30c, and 30d reverse direction and rotate back to their initial horizontal positions, pallet P′ becomes fully inverted. Once this occurs, plural transport tracks 34a, 34b, 34c, and 34d may then linearly move the inverted pallet P′ in a downstream direction (in response to movement of conventional transport drive assemblies 35) until it exits workspace/transport 20 (see FIG. 7).

The aforementioned optional pallet inverter is desirable in certain applications. In particular, it is sometime desirable to invert every other pallet after assembly and prior to stacking so that certain pallet surfaces contact one another.

Regardless of the developments noted above, one pallet-related area in which technology remains lacking is pallet stacking. While pallet stacking has been addressed to a limited extent, further developments would further improve pallet production, especially if such developments were compatible with existing pallet assembly improvements such as the apparatus and methods of the aforementioned U.S. Pat. No. 5,355,575 and/or the conventional pallet workspace and transport apparatus 20 (discussed above).

It is, therefore, a primary object of the present invention to provide improvements in pallet stacking technology which overcome the above-noted disadvantages and deficiencies of the prior art.

### SUMMARY OF THE INVENTION

The present invention satisfies the above-stated needs and overcomes the above-stated and other deficiencies of the related art by providing universal pallet stackers that are capable of receiving and stacking assembled pallets of many different sizes (without the need to reconfigure inventive stackers) to thereby enable a seamless transition between manufacturing runs of different pallet sizes.

In particular, one form of the present invention is directed to a universal pallet stacker that may include a frame, a pallet transport assembly, a pallet delivery assembly, and at least one stop plate that extends above the transport assembly. The transport assembly may include moveable transport tracks that receive an assembled pallet and move it downstream until it contacts the upstream side of the stop plate. The pallet delivery assembly may include extendable arms that: lift the pallet above the stop plate, move it downstream of the plate, bring it into contact with the downstream side of the stop plate, and slide the pallet off of the extendable arms to thereby stack the pallet in a stacking location downstream of the stop plate.

In another form, the present invention is directed to a method of using a universal pallet stacker comprising: linearly transporting the assembled pallet in a downstream direction to a stop location, elevating the assembled pallet at the stop location, moving the elevated assembled pallet to a stacking location downstream of the stop location, lowering the assembled pallet at the stacking location, and depositing the assembled pallet at the stacking location.

Numerous other advantages and features of the present invention will become apparent to those of ordinary skill in the art from the following detailed description of the preferred embodiments, from the claims and from the accompanying drawings.

### BRIEF DESCRIPTION OF THE DRAWINGS

The preferred embodiments of the present invention will be described below with reference to the accompanying drawings wherein like numerals represent like steps and/or structures and wherein:

FIG. 1 is a schematic top plan view of a conventional pallet workspace/transport together with a universal pallet stacker in accordance with one preferred embodiment of the present invention;

FIG. 2 is a schematic side elevation view of the pallet workspace/transport and the preferred universal pallet stacker of FIG. 1; and

FIGS. 3-12 are schematic side elevation views of the embodiment of FIGS. 1 and 2 illustrating a method of operating the embodiment of FIGS. 1 and 2 wherein:

FIG. 3 illustrates movement of a conventional pallet assembly workspace;

FIG. 4 illustrates transport of a newly assembled pallet;

FIG. 5 illustrates initiation of an optional pallet-inversion operation;

FIG. 6 illustrates completion of the optional pallet-inversion operation initiated in FIG. 5;

FIG. 7 illustrates transport of the inverted pallet onto the moveable transport tracks of the universal pallet stacker of the present invention;

FIG. 8 illustrates transport of the inverted pallet to an upstream side of a stop plate of the pallet stacker of the present invention;

FIG. 9 illustrates elevation of the inverted pallet above the stop plate and extension of the pallet delivery arms of the pallet stacker of the present invention;

FIG. 10 illustrates lowering of the inverted pallet below the top of the stacker stop plate until the inverted pallet contacts the downstream side of the stop plate;

FIG. 11 illustrates retraction of the pallet delivery arms of the universal pallet stacker until the inverted pallet slides off of the delivery arms and onto a previously stacked pallet in the stacking location downstream of the stop plate; and

FIG. 12 illustrates final lowering of the elevation assemblies of the preferred universal stacker to thereby complete the preferred pallet stacking operation of the present invention.

### DETAILED DESCRIPTION OF THE PREFERRED EMBODIMENTS

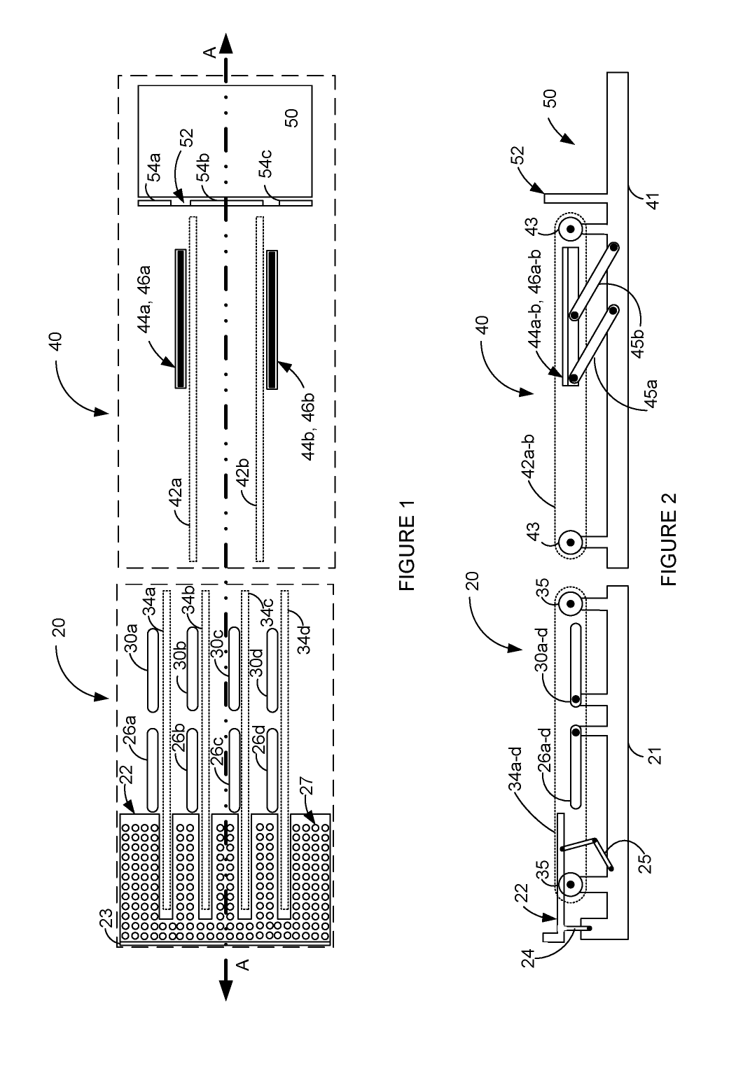

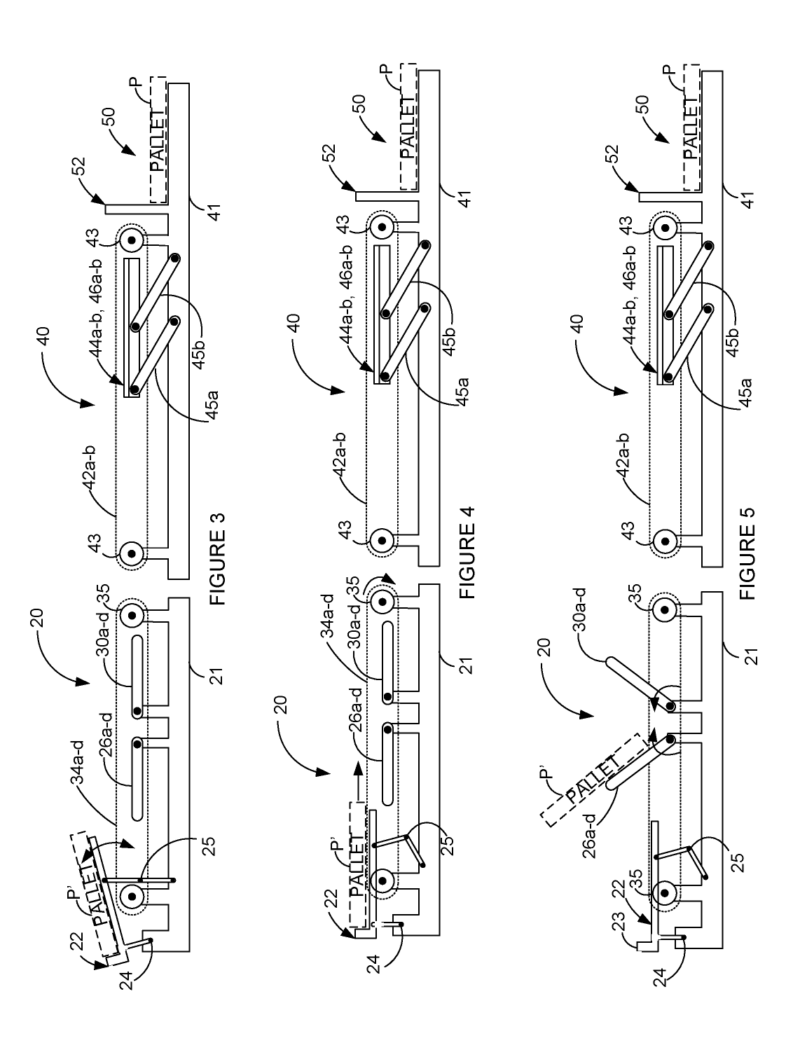

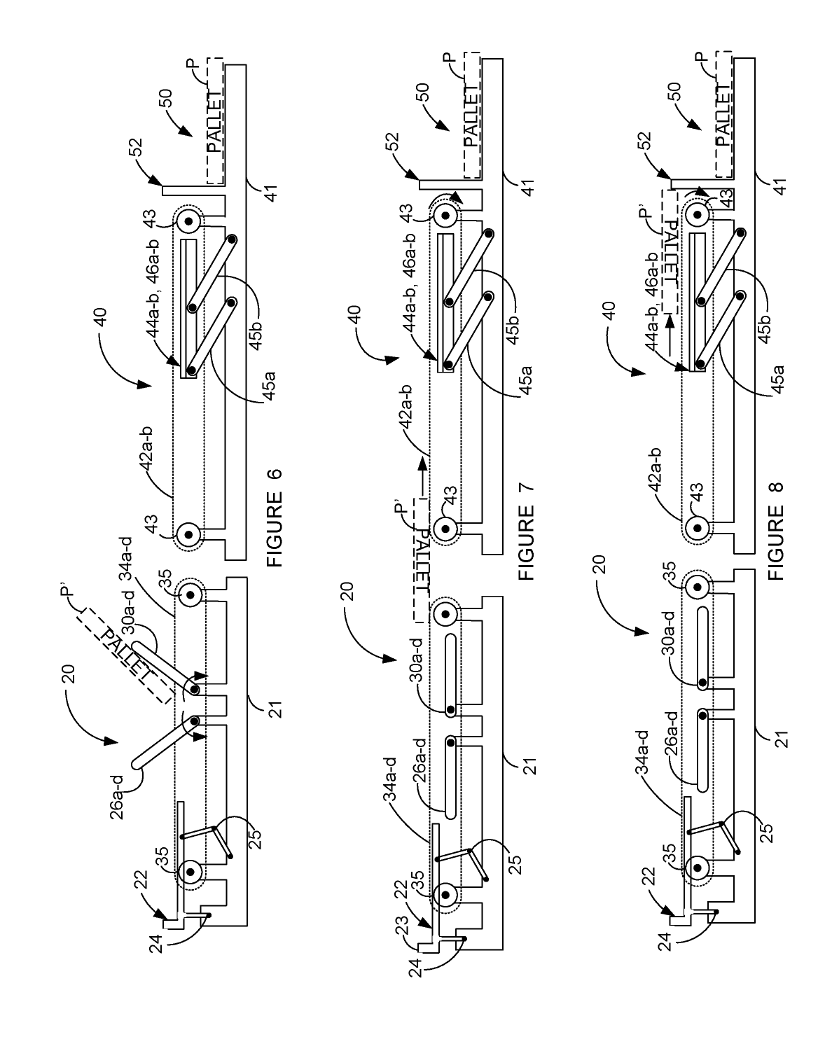

The preferred pallet stacker 40 in accordance with the present invention will be discussed below joint reference to FIG. 1 through FIG. 12. It will be appreciated that, in the example presented below, one pallet P′ is being stacked in a predetermined stacking location where a prior pallet P has already been deposited by stacker 40. That prior stacked pallet was deposited there by stacker 40 using a process that is identical to that described below with one exception. The exception is that the prior deposited pallet was not inverted before stacking. This is in accordance with a preferred method of operating the inventive stacker 40 in conjunction with conventional workspace/transport 20 in which every other pallet is inverted.

With initial emphasis on FIGS. 1 and 2, a preferred universal pallet stacker 40 is shown in conjunction with and downstream of conventional workspace/transport 20. In use, stacker 40 is fully compatible with apparatus 20 as shown and, alternatively, may also be used with a variant workspace/transport that does not include the pallet inverting assemblies shown herein. Similarly, those of ordinary skill in the art will appreciate that stacker 40 may be disposed directly downstream of (and used with) the reconfigurable pallet assembly table 22 with minor physical adaptations that enable stacker 40 to transport assembled pallets directly from table 22. For example, the moveable transport tracks 42a and 42b and transport drive assemblies 43 could be sized, shaped, and configured as a mere matter of design choice to cooperate with table 22 (such as by ensuring that transport tracks 42a and 42b may fit within the slots of table 22 to ensure transport of pallets therefrom). Moreover, it is within the skill of the ordinary artisan to place stacker 40 downstream of (and to use stacker 40 with) the PALLET MOVING DEVICE(s) taught by U.S. Pat. No. 5,355,575 discussed above.

Shown in schematic representation throughout the Figures, universal pallet stacker 40 preferably includes a frame 41 for supporting (1) a pallet transport assembly, (2) a pallet delivery assembly, (3) a segmented stop plate 52, and (4) a pallet stacker platform 50. The pallet transport assembly preferably includes first and second moveable linear transport tracks 42a/42b and one or more drive assemblies 43 for driving transport tracks 42a/42b. Transport tracks 42a/42b are preferably oriented parallel to one another and together define a downstream direction along a symmetry axis A. As shown, the pallet transport assembly preferably receives an assembled pallet P′ from transport tracks of the upstream pallet assembly workspace 20 (FIG. 7), and moves assembled pallet P′ downstream until it contacts segmented stop plate 52 (FIG. 8).

The segmented stop plate 52 preferably includes plural plates 54a/54b/54c extending above first and second transport tracks 42a/42b to thereby stop downstream transport of assembled pallets by tracks 42a/42b.

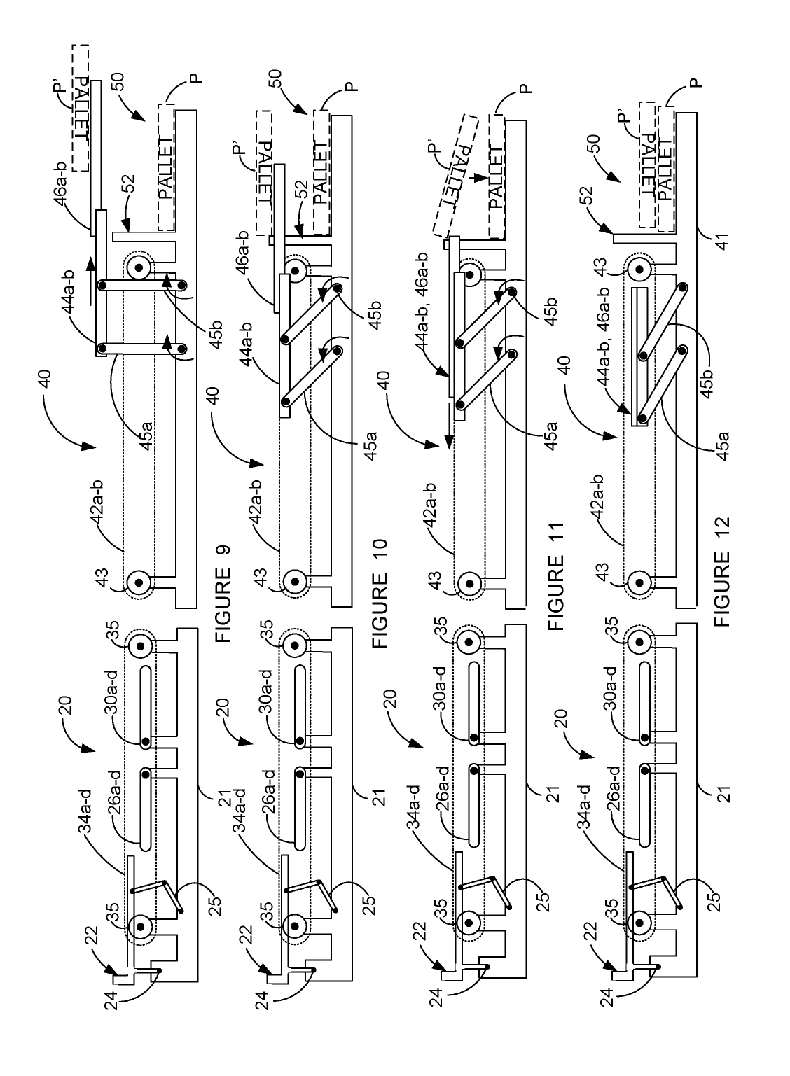

The pallet delivery assembly preferably includes extendable arm assemblies 44a/46a and 44b/46b that are preferably disposed on respective opposite sides of symmetry axis A such that they may engage assembled pallet P′ immediately upstream from stop plate 52. The pallet delivery assembly preferably also includes elevation assemblies 45a/45b for elevating extendable arm assemblies 44a/46a and 44b/46b. Elevating assemblies 44a/46a and 44b/46b will also elevate pallet P′ above plate 52 (FIG. 9). This enables arm assemblies 44a/46a and 44b/46b to extend outwardly to thereby move assembled pallet P′ to the stacking location downstream of plate 52 (FIG. 9).

Elevation assemblies 45a/45b may then lower arm assemblies 44a/46a and 44b/46b (and, with them, pallet P′) (FIG. 10). Since elevation assemblies 45a/45b preferably use pivoting motion, lowering arm assemblies 44a/46a and 44b/46b also moves assembled pallet P′ upstream until it contacts segmented stop plate 52 a second time (on the downstream side of stop plate 52) (FIG. 10). Retracting extendable arm assemblies 44a/46a and 44b/46b will, thus, cause assembled pallet P′ to slide off of assemblies 44a/46a and 44b/46b (FIG. 11) at the stacking location.

If pallet P′ is the first assembled pallet in a manufacturing run, it will be deposited onto the optional pallet stacker platform 50. If pallet P′ is not the first assembled pallet in a manufacturing run, it will be stacked on top of the most recent previous pallet to have been stacked in the stacker platform 50 area (FIGS. 11 and 12).

To complete a pallet stacking operation, elevation assemblies 45a/45b preferably then pivot back to their initial state/position. In this way, additional pallets (one by one) may be received by inventive stacker 40 and stacked together with the most recently stacked pallet at top of the stack (FIG. 12).

It will be appreciated that the coordinated operation of the pallet delivery assembly and the segmented stop plate (as described herein) are important aspects of the present invention. This is because they position each pallet to be stacked in its final stacking location before depositing the pallet (before retracting the supporting extendable arm assemblies). It has been found that, in this way, plural pallets will stack more reliably and more predictably than prior art systems.

It will also be appreciated that the above described pallet stacker does not use any side guide members and does not grasp pallets to be stacked. As such, the inventive universal pallet stacker may accommodate virtually any size pallet as long as the pallet may be balanced on extendable arm assemblies 44a/46a and 44b/46b. The preferred way to achieve this condition is to employ pairs of transport tracks and arm assemblies that are symmetrically disposed about the symmetry axis A and to process pallets in symmetric alignment with same axis. However, strict symmetry and/or alignment is not necessary to achieve this result. Restated, reasonable asymmetries and/or misalignments under the circumstances can be tolerated as long as pallets to be stacked remain balanced during processing.

While the present invention has been described in connection with what is presently considered to be the most practical and preferred embodiments, it is to be understood that the invention is not limited to the disclosed embodiments, but is intended to encompass the various modifications and equivalent arrangements included within the spirit and scope of the appended claims. With respect to the above description, for example, it is to be realized that the optimum dimensional relationships for the parts of the invention, including variations in size, materials, shape, form, function and manner of operation, assembly and use, are deemed readily apparent to one skilled in the art, and all equivalent relationships to those illustrated in the drawings and described in the specification are intended to be encompassed by the appended claims. Therefore, the foregoing is considered to be an illustrative, not exhaustive, description of the principles of the present invention.

What is claimed is:

1. A universal pallet stacker for receiving assembled pallets and for stacking the pallets in a stacking location, the stacker comprising:
a pallet transport assembly comprising,
first and second moveable linear transport tracks oriented parallel to one another to thereby define a symmetry axis and a linear downstream direction, the transport tracks receiving an assembled pallet and moving the assembled pallet in the downstream direction; and
at least one drive assembly for moving the first and second transport tracks in the downstream direction;
at least one stop plate being oriented transverse to the downstream direction to thereby define upstream and downstream sides of the stop plate, the stop plate extending above the first and second transport tracks to thereby stop downstream movement of the assembled pallet by contact between the pallet and the upstream side of the stop plate;
a pallet delivery assembly comprising:
first and second extendable delivery arm assemblies disposed on respective opposite sides of the symmetry axis, the arm assemblies being disposed for engagement with the pallet on the upstream side of the stop plate; and
at least one elevation assembly operatively associated with the arm assemblies such that the arm assemblies may lift the pallet above the stop plate, move the pallet downstream of the stop plate to the stacking location, bring the pallet into contact with the downstream side of the stop plate, and slide the pallet off of the arm assemblies to thereby deposit the pallet in the stacking location; and
a frame for supporting the pallet transport assembly, the pallet delivery assembly, and the at least one stop plate.

2. The universal pallet stacker of claim 1, wherein the first and second linear transport tracks are disposed symmetrically on opposite sides the symmetry axis, and wherein the first and second extendable delivery arm assemblies are disposed symmetrically on opposite sides the symmetry axis.

3. The universal pallet stacker of claim 1, wherein the stacker further comprises a pallet stacking platform at the stacking location.

4. The universal pallet stacker of claim 1, wherein the at least one stop plate comprises a segmented stop plate oriented transverse to the downstream direction to thereby define upstream and downstream sides thereof, and wherein the segmented stop plate extends above the first and second transport tracks to thereby stop downstream movement of the assembled pallet by contact between the pallet and the upstream side of the segmented stop plate.

5. The universal pallet stacker of claim 1, wherein the first and second arm assemblies have respective first and second pivoting elevation assemblies operatively associated with the arm assemblies such that the arm assemblies may lift the pallet above the stop plate, move the pallet downstream of the stop plate to a stacking location, bring the pallet into contact with the downstream side of the stop plate, and slide the pallet off of the arm assemblies to thereby deposit the pallet in the stacking location.

6. A method of operating a universal pallet stacker of the type that receives assembled pallets, the method comprising:
linearly transporting the assembled pallet in a downstream direction to a stop location;
elevating the assembled pallet at the stop location;
moving the elevated assembled pallet to a stacking location downstream of the stop location;
lowering the assembled pallet at the stacking location; and
depositing the assembled pallet at the stacking location.

7. A universal pallet stacker of the type that receives assembled pallets from a pallet assembly workspace, the method comprising:
means for linearly transporting the assembled pallet in a downstream direction to a stop location;
means for elevating the assembled pallet at the stop location;
means for moving the elevated pallet to a stacking location downstream of the stop location;
means for lowering the assembled pallet at the stacking location; and
means for depositing the assembled pallet at the stacking location.

8. The universal pallet stacker of claim 7, wherein the means for elevating, moving, lowering, and depositing comprises:
a pallet delivery assembly comprising:
first and second extendable delivery arm assemblies disposed for engagement with the pallet upstream of the stop plate; and
at least one elevation assembly operatively associated with the arm assemblies such that the arm assemblies may lift the pallet at the stop location, move the pallet downstream of the stop location to a stacking location, lower the pallet, and slide the pallet off of the arm assemblies to thereby deposit the pallet in the stacking location.

9. The universal pallet stacker of claim 7, wherein the means for linearly transporting the assembled pallet in a downstream direction comprises a pallet transport assembly comprising:
first and second moveable linear transport tracks oriented parallel to one another to thereby define a symmetry axis therebetween and to thereby define a linear downstream direction, the transport tracks receiving the assembled pallet and moving the assembled pallet in the downstream direction; and
at least one drive assembly for moving the first and second transport tracks in the downstream direction.
